(19) United States
(12) Patent Application Publication
(10) Pub. No.: US 2006/0167776 A1
(43) Pub. Date: Jul. 27, 2006

(54) Affordable for-sale housing program

(76) Inventor: Cathal Conaty, Dublin (IE)

Correspondence Address: FISH & RICHARDSON PC, P.O. BOX 1022, MINNEAPOLIS, MN, 55440-1022, US

(21) Appl. No.: 11/043,272

(22) Filed: Jan. 25, 2005

(51) Int. Cl. G06Q 40/00

(52) U.S. Cl. 705/35

(57) ABSTRACT

A method and apparatus for providing and administering an affordable housing program. A property is located for which a developer has received tax credits in exchange for constructing affordable housing units on the property. By machine, information is stored into a database regarding the property. The tax credits held by the developer are sold to investors. The developer uses the equity received from the tax credits to finance, in part, construction of the affordable housing units. Ownership of the housing units are transferred to qualified buyers and ownership of the affordable housing units are tracked.

### TECHNICAL FIELD

This disclosure relates to providing affordable for-sale housing to low-income families using tax credits to attract private-sector investment.

### BACKGROUND

For many low-income households, owning a home is an unattainable dream. Low-income households spend years paying rents that could be used as monthly payments for a new home. Rather than spending money on rent, low-income families could save money and build wealth by owning their own home. However, in many cases, the prerequisite down payment to obtain a mortgage poses a formidable obstacle to low-income households. Furthermore, the high cost of ownership housing has made it difficult for governments to assist low-income households to qualify to purchase a home due to a large subsidy that is needed.

### SUMMARY

According to an aspect of the invention, a method includes locating a property for which a developer has received tax credits in exchange for constructing affordable housing units on the property and by machine, storing information regarding the property into a database. The method also includes selling the tax credits held by the developer to an investor, the developer using equity received from the tax credits to finance, in part, construction of the affordable housing units, transferring ownership of the housing units to qualified buyers and tracking status of ownership of the affordable housing units.

The following embodiments are within the scope of the invention. Tracking the affordable housing units include marking a deed to a housing unit with a restriction, the restriction indicating that at least one requirement must be met before the low-income household may sell the housing unit and by machine, storing information pertaining to the deed in a database. The method includes verifying the eligibility of a family who applies for an affordable housing unit. The tax credits represent one-to-one tax compensation. The method of includes generating a joint venture agreement between the investor and the developer, the joint venture agreement being a legally binding document and by machine, storing the joint venture agreement in electronic form in a database. The method also includes pooling the tax-credited properties into funds, selling the funds to the investors and by machine, storing information pertaining to the funds in a database. The method includes determining if the low-income household wants to sell the housing unit; and by machine, indicating in the information concerning the deed that the restriction on the deed was lifted. The method also includes generating reports displaying information that includes the properties for which a developer has received tax credits, the tax credits held by investors, changes in ownership of the affordable housing units; and profits generated by sales of the affordable housing units.

According to an additional aspect of the invention, a system for providing affordable for-sale housing to low-income families using tax credits supplied from a government agency includes at least one client computer connected to a network, the client computer configured to receive information regarding a property for which tax credits have been allocated for affordable housing and a record of a sale of tax credits allocated to the property, at least one database for storing information pertaining to the affordable housing units and a server connected to the network and to the database, the server configured to receive and transmit data between the client computer and the database; and to track the housing units.

The following embodiments are within the scope of the invention. The database stores information regarding the tax credits. The database stores an electronic copy of a joint venture agreement between the investor and the developer. The system includes a process to pool the tax credits into funds including other tax credits on other properties. The information pertaining to the affordable housing units comprises completion progress, deed information, ownership information, and sales of the units. The client computer reports a portion of the information held in the database.

According to an additional aspect of the invention, a computer readable medium having instructions stored thereon, that, when executed by a processor, causes the processor to store information regarding a property allocated for affordable housing into a database, record an allocation of tax credits issued by a government agency to a developer of the property, record a deed to an affordable housing unit on the property to a low-income family and track the affordable housing unit.

The following embodiments are within the scope of the invention. The computer readable medium causes the processor to pool the tax credits into funds. The processor stores a joint venture agreement between the developer and an investor. Tracking includes storing information pertaining the deed to the affordable housing unit, that the deed includes a restriction, the restriction indicating that at least one requirement must be met before the low-income household may sell the housing unit and storing information pertaining to the deed when the restriction is removed when the at least one requirement is met. Tracking further includes detecting if the low-income family is trying to sell the housing unit and detecting a foreclosure of the housing unit. The processor provides a report to a user containing information concerning the affordable housing unit. The information concerning the affordable housing unit comprises: completion progress, deed information, ownership history, and financial information.

According to an additional aspect of the invention, a method includes locating a property for which a developer has received tax credits in exchange for constructing affordable housing units on the property, selling the tax credits held by the developer to an investor, using by the developer equity received from the sale of the tax credits to finance, in part, construction of the affordable housing units; and transfer the affordable housing units to qualified purchasers. The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows a block diagram representing transaction flows in an affordable housing program.

FIG. 2 shows a block diagram of a computing system that administers the affordable housing program of FIG. 2.

FIG. 3 is a flow diagram of a process for pooling investments and allocating tax credits.

FIGS. 4A and 4B are flow diagrams of a process for administering housing units.

### DETAILED DESCRIPTION

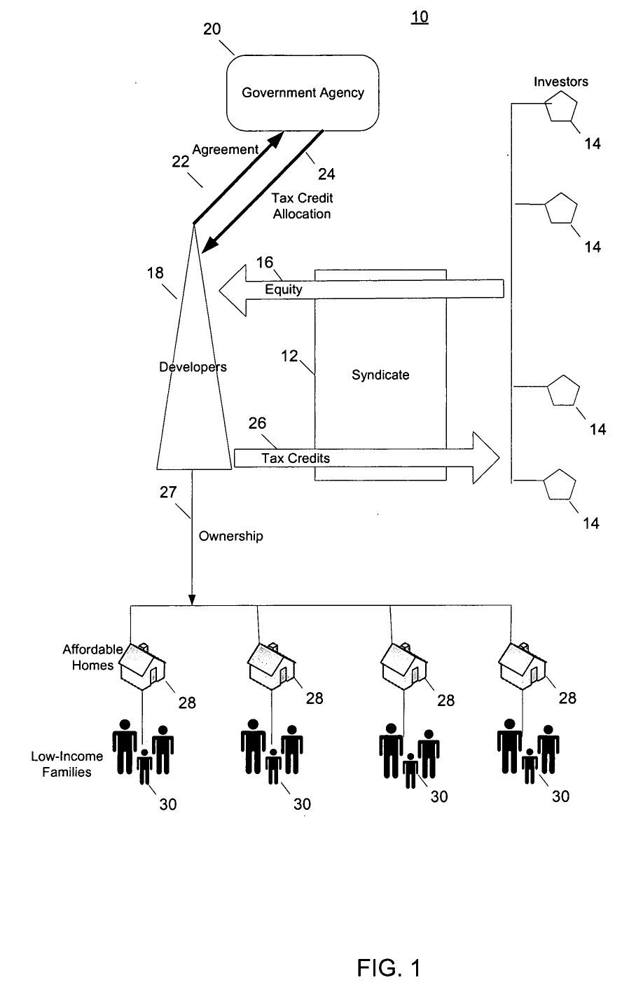

Referring to FIG. 1, an affordable housing program 10 provides affordable homes 28 to low-income families. The affordable housing program 10 includes several parties: syndicator 12; investors 14; a government agency 20; developers 18; and low-income families 30. The term ‘syndicator’ is used to refer to an entity that manages multiple funds, each of which may be described as a syndicator, e.g., a group of investors who join together to finance a specific number of developments. The syndicator sets up and manages these funds. A developer 18, planning to build a residential property, takes an option on a site, plans the development, arranges a construction loan, and obtains building permission. In return for making ownership 27 of the houses affordable to low-income families 30, the government 20 allocates an amount of tax credits 24 to that property. With the help of a syndicator 12, groups of investors 14 provide the developer 18 with the equity 16 needed to construct the property in return for the right to use the tax credits 26. The tax credits 26 reduce the taxes that the investors 14 would otherwise pay in the future. After construction is completed, affordable for-sale homes are sold directly to the low-income families 30 at a discount from the market price. In some embodiments, the discount can be a fixed amount, e.g., 25%, 50% or other amounts whereas in other embodiments the discount can be determined based on statistical measures of household income for low or very low income individuals in a particular region compared to the applicant's income.

As set forth in an agreement 22, the tax credits 26 are used by the investors 14 as the equity 16 is spent on constructing the housing units 28. The agreement 22 will require the majority of the tax credits 26 to be held back until after the successful delivery of the property, and to be spread out over a number of years. Unlike other property tax incentives, the tax credits 26 are targeted directly at producing affordable housing. Units 28 are sold at affordable prices to low-income families 30. Furthermore, the cost to the government is in the form of taxes foregone, rather than increased government spending. This is generally considered more appropriate with regard to government spending targets. In return for providing the tax credits 26, the government agency 20 retains a long-term ownership interest in the properties and receives a portion of the profits when the individual homes 28 are resold. The low-income families 30 receive the remaining portion of the profits.

The following example further illustrates the affordable housing program 10. In this example, a developer 18 constructs a housing unit 28, earmarked for affordable housing, with a market value of, e.g., $100,000. The developer's total costs for building the unit is, e.g., $90,000; therefore, the developer 18 would make a profit of $10,000 upon the sale of the unit 28. If the government agency 20 grants tax credits on 75% of the market price for the affordable housing unit 28, the developer 18 receives $75,000 worth of tax credits. Furthermore, the tax credits 26 are to be taken over 15 years. With the help of a syndicator 12, the developer sells the $75,000 worth of tax credits to investors 14 in exchange for equity in the amount of $50,000. The developer 18 uses the equity to cover $50,000 of the construction costs enabling the developer 18 to sell the unit 28 at half of its original market value or $50,000. The developer has an remaining construction cost of $40,000 and still desires to maintain its $10,000 profit. Thus, in this example the government has supplied tax credits in the amount of $75,000 that generated $50,000 of equity which is used by the developer to reduce its effective cost to $40,000 enabling the developer to sell the unit for $50,000 a still obtain a $10,000 profit. Normally the developer 18 would invest $90,000 of capital to obtain a $10,000 profit, but under the program 10, the developer 18 can invest $50,000 of capital to receive the same $10,000 profit. The program 10 is advantageous to the developer 18 because the developer 18 receives a larger profit from the capital invested, and because the developer's risk of being unable to sell the home is greatly reduced, because it is being sold for half the market price. A low-income family 30 takes a mortgage for $50,000 to buy the house 28.

At some later point, the family 30 sells the house for $110,000. An amount of $50,000 (minus any principal that was already paid by the family) from the sale would be applied to pay off the mortgage and an amount of $50,000 would be returned to the government agency 20 to have it recoup part of the tax credits granted. Furthermore, a percentage of the $10,000 profit would be paid to the government agency 20 while the remaining profit would be paid to the family 30. Generally, the percentage of the profit retuned to the government agency would be based upon the initial subsidy, which in this example was 50%. Other arrangements could of course be used. For instance, the government agency could keep more or less of the profit. Alternatively, the portion of the profit returned to the government agency can be based on a sliding scale according to the amount of time that the family owns the house.

On the other hand, if the family 30 sells the house for $90,000. An amount of $50,000 (minus any principal that was already paid by the family) would still be used to pay the mortgage; however, the government would receive only $90,000 less the amount required to repay the remainder of the mortgage, thus possibly incurring a loss of up to $10,000 and the low income family would not receive any net proceeds from sale of the unit.

The government agency 20 could be a Housing Authority or a Housing Commission operated at the federal, state, county, or city level. In addition to receiving a portion of the profit from the sale of the units 28, the government agency 20 collects taxes on the sale of units 28 and taxes on construction earnings. The government agency 20 also has the opportunity to sell (at a market price) all or part of government owned land for use in the program 10. In addition to making for-sale housing more affordable to low-income families 30, the program 10 can be financially profitable for the government agency 20.

The government agency 20 is responsible for allocating the tax credits 24 to developers 18. Allocation 24 could be accomplished through a competitive process in which developers 18 get planning permission, submit the project to the tax credit allocation committee for the state. The tax credits 26 are generally allocated based on criteria that vary by state but that most strongly consider the shortage of affordable homes and the overall benefit to a community.

Additionally, the government agency 20 is responsible for ensuring that the housing units 28 comply with any rules or specifications set forth by the government agency 20. Compliance checking can be performed by a private contractor or a government official. The government agency 20 might include the fees for compliance checking into the costs of the property.

Developers 18 include for-profit and non-profit housing construction companies. The developer 18 receives tax credits 26 from the government agency 20 in return for constructing affordable housing units 29. The developer 18 may sell the tax credits 26 to investors 14 and use the equity 16 obtained from the sale to fund a portion of the costs of construction which could include a developer's fee. The remainder of the costs are preferably financed with a construction loan. The units 28 are then sold at reduced prices to low-income households 30. The sales proceeds are used by the developer 18 to pay off the construction loan.

The affordable housing program 10 provides additional profit to the developer 18 to make affordable housing as attractive as market rate housing. With market rate housing, the developer 18 has upside potential in a rising market. With affordable housing the developer 18 cannot profit from a rising market because the prices are set in advance. To compensate the developer 18 for this loss of upside potential the developer receives a reasonable profit ($10,000 in the example above), coupled with the knowledge that, in a weak market, the developer's risk that the units will not sell is reduced almost to zero under the affordable housing program 10.

The developer 18 guarantees completion of the units 28 and covers the cost of any overruns. Additionally, the developer 18 guarantees the construction loan, which means that if the units 28 are not completed or do not sell (which is highly unlikely given the price advantage over market-rate units), the developer 18 is liable for the monetary loss. The developer 18 preferably indemnifies the investors 14 against recapture of the credits 26 in the event that the developer 18 has failed to comply with any terms of a joint venture agreement between developer 18 and the investor 14. Examples of such terms are described below. Once the unit is sold to the low-income household, neither the developer 18 nor the investor 14 have any further involvement; the investor 14 simply uses the tax credits 26 over a predetermined number of years as set forth in an agreement with the government agency 20.

The tax credits 26 are preferably useable by any taxable investors which include workers whose taxes are deducted at source, self-employed workers, proprietary directors, and companies. Tax credits 26 preferably reduce taxes on any income: domestic, foreign, earned, and passive. Furthermore, the tax credits 26 preferably represent one-to-one tax compensation, i.e., one dollar of tax credit reduces taxes by one dollar. Tax credits 26 could also be tax deductions; however, one-to-one tax credits are preferred over tax deductions and so make it more feasible to raise the required amount of equity in order to deliver a sufficient volume of affordable housing. Investors 14 may be individuals or companies, small and large. The program 10 can provide widespread benefits and be attractive to investors 14 having a wide range of incomes. Because the investor 14 in effect purchases tax credits 26 to reduce taxes in the future, the investor 14 runs the risk of having no tax liability against which to apply the tax credits 26 if future income were to fall significantly. If income were to fall, then the return on the investment would be greatly reduced or possibly negative.

The investor 14 preferably invests money 16 in stages (e.g. 20% of the total investment upon final permitting, 30% upon 50% completion of the housing units 28, 30% upon substantial completion and the remainder when the final units 28 are sold and the construction loan is repaid). There is some risk that the property will never be completed, and that the tax benefits 26 will never materialize. However, this risk can be mitigated by a construction completion guarantee by the developer 18, and in some cases by a completion bond. In a different scenario, the investor 14 could invest money 16 only upon completion of the units 28, but in that case the interest savings do not occur, and either the level of affordability or the developer's profit will likely suffer as a result.

The investor 14 also bears some tax credit recapture risk if the property falls out goes bankrupt prior to the sale to the low income family, or if the developer sells the home to a non-qualifying family. Future tax credits could be withdrawn and tax credits already taken could be recaptured if this occurs. Preferably, the program 10 will include provisions, agreed to by the investor 14 and the developer 18, that require the developer 18 to indemnify the investor 14 against such an event. Once the units 28 are sold to qualifying households 30, the investor 14 is no longer exposed with regard to compliance.

A syndicator 12 is a company that works primarily as a middleman between investors 14 and developers 18 in the affordable housing program 10. The syndicator's responsibilities include finding developers 18 with sites that are approved for affordable housing 28, persuading investors 14 to invest in the sites in exchange for tax credits 26, and underwriting agreements between developers 18 and investors 14.

A syndicator 12 may act as a clearing-house to assist investors with spreading their equity among many developers and many sites to diversify their risk. A syndicator 12 might evaluate the economics of individual properties. Most large investors would rather choose a syndicator 12 carefully and let the syndicator 12 study the individual properties. The responsibilities of the syndicator 12 can also include developing standard legal documents. Standardization of legal documents facilitates joint ventures between developers 18 and investors 14 and helps to avoid problems with loopholes that might be present in individual or non-standard legal documents. Syndicators 12 might perform an asset management function on behalf of investors 14 to help detect and resolve problems expeditiously.

A syndicator 12 often pools properties into funds to help make investing more efficient and enable safeguards to be built into the funds. The syndicator 12 frequently charges a fee or sets aside a small percentage of the investor's money as a fund reserve to be used to deal with unforeseen future problems. Fund reserves might be held in addition to the fee but may be returned to the investor 14 if they are not used. Syndicators 12 also ensure that the funds are audited, and that the investors 14 receive accurate tax information in time for their tax return deadlines. Syndicators 12 would preferably have the following capabilities: relations with developers 18 and knowledge of which developers 18 have which sites tied up; links to a broad base of investors 14, preferably in collaboration with one or more financial intermediaries; legal documents that protect the investor 18 from risks during the development and sale period and that protect the syndicator 12 from false claims by investors 18. A syndicator 12 would preferably have lawyers to negotiate final joint venture documents; and asset managers to oversee the progress of a development.

The housing units 28 would likely be built in a country or a state in proportion to the existing population and existing low-income needs. These needs may be measured using the number of low-income households 30 on each local authority's waiting list. Because land values can vary widely across a country or state, the amount of tax credits 26 per unit 28 may also vary. For example, the amount of credits might be proportional to the market value of the units 28.

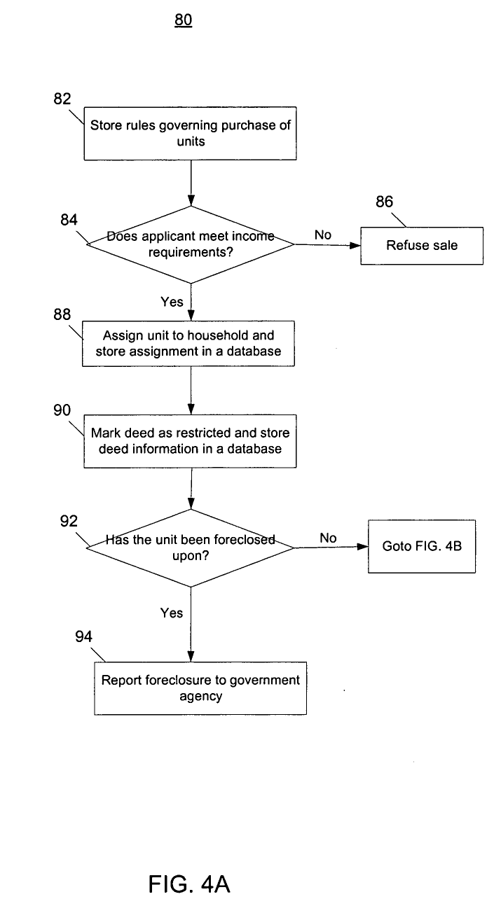

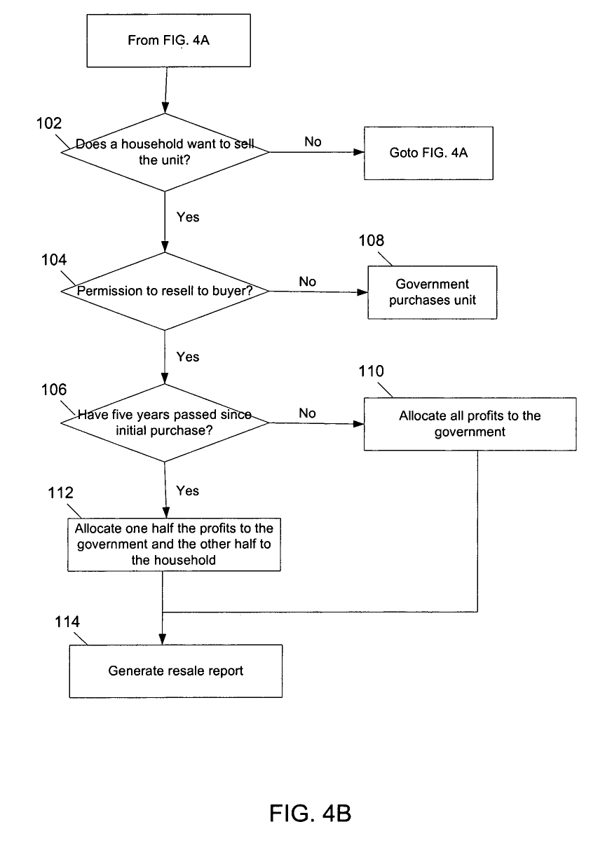

The key benefit of the program 10 to low-income households is partial ownership of a unit 28 that they could probably never obtain at market prices. A family may qualify as a low-income household 30 if its annual gross income falls below a certain level. Rules governing the sale of housing units 28 to low-income households 30 are discussed later in conjunction with FIG. 4A. With for-sale units 28, the households 30 take the same financial risk that other homeowners take, albeit at a lower level. Mortgages on the units 28 will have the same rules and foreclosure risks as the mortgages on any market-value homes. To reduce their mortgage payments a low income family 30 could borrow for longer periods, say up to 40 years. Low-income households 30 may be required to pay an additional monthly property service charge. If the household 30 sells the unit 28 at a profit, the household 30 may be eligible to receive a portion of the profit.

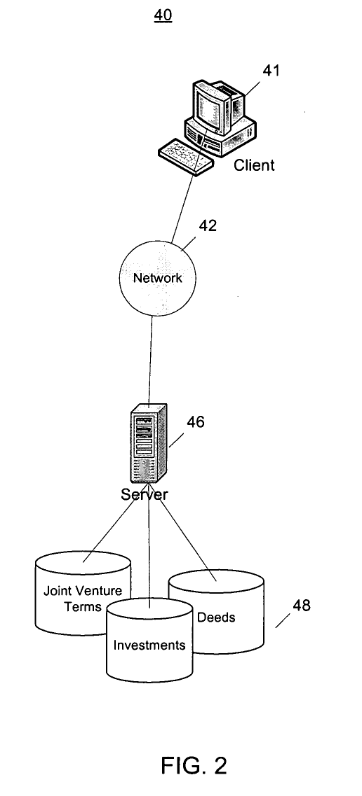

As shown in FIG. 2, in a computing system 40 configured to administer the affordable housing program 10, a user accesses databases 48 via a client computer 41 connected to a remote server 46 over a network 42. Multiple users could access the databases using multiple client computers connected to the network 42. The users could be a syndicator 12, a developer 18, an investor 14, and a government agency 20. The affordable housing program 10 may be implemented using software operable on the remote server 46 and the client computer 41. The software causes the computing environment 40 to perform functions specified by the user. Such functions performed by the user could include searching property allocated for affordable housing 28, pooling properties into funds, allocating tax credits 26 to investors 14, storing joint venture agreements between developers 18 and investors 14, recording sales of housing units 28 to low income households 30, tracking the housing units 28, and generating custom reports.

In order to implement the affordable housing program 10, the software may access information related to joint venture terms, investments, and deeds stored in databases 48. The databases can be on the same remote server 46 as the software or a different remote server (not shown). The syndicators 12, investors 14, developers 18, and government agencies 20 communicate with the server 46 over a network 46, for example, a direct dial connection, a local area network (LAN), a larger group of interconnected systems such as the Internet, a private intranet, or other similar wired or wireless network. Furthermore, the network 42 is simplified for ease of explanation. The network 42 can include more or fewer additional elements such as networks, communication links, proxy servers, firewalls or other security mechanisms, Internet Service Providers (ISPs), gatekeepers, gateways, switches, routers, hubs, client terminals, and other network elements.

A suitable network protocol, such as the TCP/IP protocol, may be used for the communications. Communications through the network 42 may be secured with encryption, a security protocol, or other type of similar security mechanism. Communications through the network 42 can include any kind and any combination of communication links such as modem links, Ethernet links, cables, point-to-point links, infrared connections, fiber optic links, wireless links, cellular links, satellite links, and other similar links.

The client computer 41 or user may be any computer or computers used by those skilled in the art, and such client computers 41 may allow remote users to access the system 40. The client computer 41 may comprise a central processor unit (CPU) and main memory, an input/output interface for communicating with various databases, files, programs, and networks (such as the Internet), and one or more storage devices, such as a hard disk. The client computer 41 may also have a monitor or other screen device and an input device, such as a keyboard or a mouse. The client computer may also have some software programs contained in the main memory or the storage devices which can be used by the CPU. In one embodiment, a web browser, may be part of the software programs on the client computer 41. The central processing unit may use the browser software package to display information from a web page on a monitor.

The server 46 may comprise web servers and application servers or any combination thereof, and may be any computer known to those skilled in the art. The web servers and the application servers can be separate entities, or may exist within a single computer or computer system. This specification will refer to both possibilities as remote server 46. The server 46 allows access by the users to information stored in databases 48. Databases 48 could also be a single database. The server 46 may be separated and protected from the network 42 by a security mechanism such as a firewall. The server 46 may also have access, via the network 42, to external data sources.

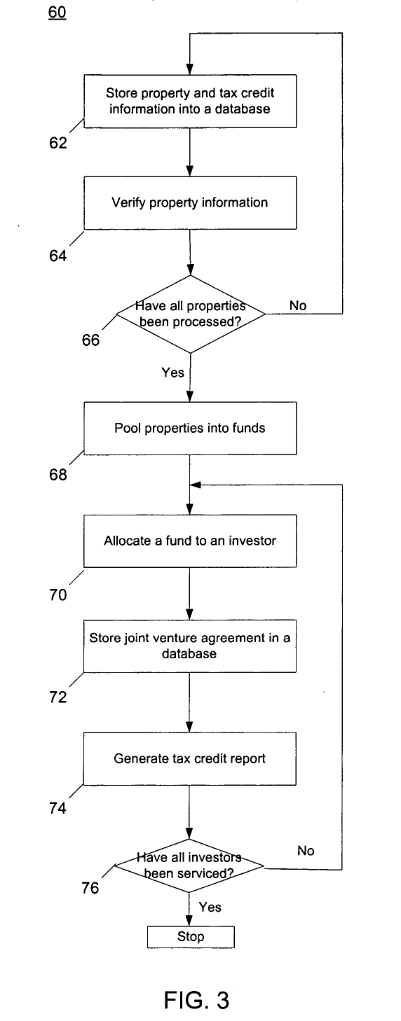

Referring to FIG. 3, a process 60 for pooling investments and allocating tax credits is shown. The steps shown in the flow diagram 60 would likely be initiated by a syndicator 12 from a client computer 41. The syndicator 12 works as a middleman to connect developers of tax-credited property with investors who want to purchase tax credits. Once a syndicator 12 locates tax credited properties, the syndicator 12 verifies the property information 62. The verification process 62 includes determining the tax credits allocated to the properties, checking the financial records and references of a developer 18 and any subcontractors, and verifying that the developer 18 and any subcontractors are properly insured. The syndicator 12 enters the property information, including the tax credit totals, developer information, and subcontractor information if applicable, into a database. The syndicator 12 completes steps 62 and 64 until all the tax-credited properties are processed 66.

Properties are pooled into one or more funds 68 that may be groupings of tax-credited properties. A fund might contain properties belonging to the same developer or properties spread across multiple developers. Pooling properties together as funds generally makes investing more efficient, enables safeguards to be built in, and helps investors 14 to diversify their risk. Funds are allocated to one or more investors 70. The syndicator 12 will likely set aside a small percentage, i.e. 3%, of investor's money as a fund reserve to be used to deal with unforeseen problems, such as bankruptcy.

To protect the interests of the investor 14 and the developer 18, a legally binding joint venture agreement is preferably negotiated and signed by both parties.

A syndicator 12 preferably uses standard joint venture development documents to help standardize the industry in order to make forming such agreements more efficient for investors and reduces problems with loopholes in individual joint venture documents. A joint venture agreement typically includes:

1. The amount of equity 16 to be contributed by the investors, and the stages at which the equity is to be contributed. A typical arrangement might be:

a) 30% of the total equity 16 upon issue of final permits,

b) 20% of the total equity 16 at 50% completion,

c) 20% of the total equity 16 at issuance of certificates of occupancy on all units, and

d) 30% of the total equity 16 at the closing of the sale of the final unit and repayment of the construction loan. The last installment pays the developer fee.

2. The amount of credits that the property will generate.

3. A tax credit adjuster that allows the investors to decrease the amount of their investment if the amount of credits generated is less than projected. Depending on the ability and willingness of the investors to absorb more credits, there could also be an upward adjuster to provide for more equity if more credits are generated.

4. A repurchase obligation that obliges the developer to buy the investors out if the property is foreclosed upon during the development period.

5. A completion guarantee by the developer which could be both corporate and personal on the part of the principals of the developer.

6. An indemnity agreement, under which the developer indemnifies the investors against non-compliance during the development or sale of the property. For example, if non-compliance is discovered at a later date and the credits are recaptured as a result, the investors could call on this indemnity and the developer would compensate them.

7. Usual legal assurances including that the developer 18 and the syndicator 12 have legal existence, that the developer 18 truly owns the land, that title insurance has been obtained, that only licensed and insured contractors will be used.

8. Provisions allowing the investors 14, or the syndicator 12 acting on their behalf, to give notice to the developer 18 in case of major defaults which might include fraud or gross negligence, failure to meet development targets, and personal or corporate bankruptcy.

9. Provisions allowing the investor 14 to buy the developer 18 out at a reduced rate in the case of minor defaults such as repeated delays in providing property financial reports. These terms are always individually negotiated depending on the circumstances of the deal and how much value the developer has put in.

10. Provisions giving the investors the right to approve certain major decisions, such as selling or refinancing the property, assigning the developer's rights and obligations to anyone else, making any elections that affect the taxes of the investors etc.

11. Provisions allowing for the continuation of the joint venture if one of the parties dies or goes bankrupt.

12. Provisions allowing for the withdrawal of the developer 18 and the investors 14 from the joint venture once the property 28 has been built and sold to low-income households 30.

13. Provisions governing accounting and financial reporting. These would identify all key tax issues that might affect the returns to investors 14, and to obligate the developer 18 to make the right choices on these issues. These clauses also cover the nature and timelines of reporting to investors 14.

After the terms of a joint venture agreement have been successfully negotiated, the joint venture agreement is stored in a database 72 that either party can access in the future. Once the units 28 have been sold to low-income households 30, neither the developer 18 nor the investor 14 have any further involvement in the program 10. The investor 14 uses the tax credits according to the timeline and milestones laid out in the joint venture agreement. Tax information is automatically generated and reported to the investors 14 in time for their tax return deadlines. The tax information could be delivered to the investors 14 via a secure webpage or as a hardcopy report. Procedures 70, 72, and 74 are completed for each investor 14 until all investors have been serviced 76.

Referring FIG. 4A and FIG. 4B a flow diagram 80 for selling and tracking housing units 28 is shown. Rules governing who may purchase the housing units 28 are stored in a database 82. Units 28 are preferably only sold either to a housing authority or to households with a gross annual income of less than a predetermined amount. The amount is a published figure that is calculated in proportion to the local median income. For example, in a very poor locality, a rule might state that a household of one person is eligible if their gross annual income is less than $10,000 while a household of two people are eligible if their gross annual income is less than $15,000. Income limits could be indexed annually to a national wage growth value that is periodically published.

The developer 18 is typically responsible for verifying the household income of the purchaser, though the developer could hire another company or contractor to perform the verification. A developer 18 could verify the whether or not the applicant meets the income requirements 84 using the following methods or a combination thereof.

1. Obtain a declaration by the purchaser certifying his or her income (under penalty of prosecution for fraud) to the developer 18 and the government agency 20.

2. Acquire the purchaser's year-end income tax forms for the previous year.

3. Require the purchaser to provide a letter from the purchaser's employer stating the average monthly wages of the purchaser.

4. Request to purchaser to submit any payslips for the previous 3 months.

5. Obtain a certification from a government agency that the purchaser's income meets eligibility requirements.

For units to be bought by the local authority for social housing, the developer 18 might require a letter from the local authority stating that the unit is exempt because the local authority will administer it under its own guidelines. The developer 18 will refuse to sell the unit 86 to a household that does not meet the income requirements.

If the applicant qualifies as a low-income household 30, a unit 28 is assigned to the applicant. The assignment is stored in a database and may include the applicant's social security number, a deed, and any other information related to the household 30 and unit 28. The deed to the unit 28 is marked as restricted and stored in a database 90 to indicate that further requirements must be met before the deed can be resold to another purchaser. The deed with the restriction is also registered in a county registry of deeds in the county where the property is located, as with other deeds. Deeds to the units 28 are restricted to help prevent profiteering and to ensure that the government agency 20 collects payments due when the unit is resold. For the deed to be resold, the deed restriction might require written permission from the government agency 20. Once the restriction requirements are met, the restriction is lifted and recorded in the database so that the deed may be resold.

After the units 28 have been sold, the units are tracked and information on the units is periodically updated. The tracking of units 28 can detect when a unit has been foreclosed upon and when an owner 30 is trying to sell the unit 28.

If the system detects that a unit has been foreclosed upon 92, generally because the household 30 failed to make its mortgage payments, the government agency 20 is immediately notified 94. In the event of foreclosure, the government agency 20 may accept foreclosure and sale of the unit 28 or assume the debt on the unit 28 in return for the surrender by the household 30 of their ownership interest leaving the unit 28 free to be resold to another buyer. To make the foreclosing process more efficient for lenders, the mortgage documents signed by the household 30 might specify a time limit for the government agency 20 to choose one of these options. If the government does not choose within the time limit, the first option could become binding.

If the system detects that household 30 wants to sell their unit 28 (102), a notification will be sent to the government agency 20. Upon receiving appropriate permission from the government agency 104, the deed restriction is lifted and the unit 28 is sold. The government agency 20, however, might not approve the sale of the unit 28 to the selected buyer. Non-approval could result if the government agency 20 believes that the household 30 is profiteering off the sale of the unit 28. For example, a household 30 might try to sell their unit 28 for much less than the market price to a friend, who in return, might privately refund the difference to the household 30 thereby excluding the government agency 20 from a portion of the returns from the sale. In this case, if the government agency 20 suspects that the household 30 is pricing the unit 28 too low, the government agency 20 could purchase the unit 28 (108) at the low price to prevent fraud.

If the government agency 20 deems the sale to be legitimate, the system calculates the portion of the profit that is to be allocated to the government agency 20 and the portion to be allocated to the low-income household 30. For example, if five years have passed since the unit 28 was initially purchased 106, half of the profits could be allocated to the government agency 20 and the other half would be allocated to the low-income household 30. On the other hand, if household 30 sells the unit 28 within less than five years of purchasing it 106, the government agency 20 could retain all profits from the sale 110. Other arrangements are possible. Upon completion of the sale and allocation of profits, a resale report is generated 114 and delivered to the government agency 20. A copy of the report is retained by the syndicator. The report contains information related to the sale of the unit 28 which could include the tax credit allocation 24 assigned to the property, the initial sale price of the unit 28, the re-sell price of the unit 28, any profit generated, and the amount of profit allocated to the government agency 20 and to the household 30.

The affordable housing program 10 may be implemented, in part, by one or more programmable processors executing a computer program to perform functions of the program 10 by operating on input data and generating output. The program 10 may also be implemented, in part, using special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of embodiments of the invention, or any combination of such back end, middleware, or front end components. The components of the system can be interconnected by any form or medium of digital data communication, e.g., a communication network. Examples of communication networks include a local area network (LAN) and a wide area network (WAN), e.g., the Internet.

The system and method of the invention may use the “World Wide Web” (Web or WWW), which is that collection of servers on the Internet that utilize the Hypertext Transfer Protocol (HTTP). HTTP is a known application protocol that provides users access to resources, which may be information in different formats such as text, graphics, images, sound, video, Hypertext Markup Language (HTML), as well as programs. Upon specification of a link by the user, the client computer makes a TCP/IP request to a Web server and receives information, which may be another Web page that is formatted according to HTML. Users can also access other pages on the same or other servers by following instructions on the screen, entering certain data, or clicking on selected icons. It should also be noted that any type of selection device known to those skilled in the art, such as check boxes, drop-down boxes, and the like, may be used for embodiments of the invention using web pages to allow a user to select options for a given component. Servers run on a variety of platforms, including UNIX machines, although other platforms, such as Windows 2000, Windows NT, Sun, Linux, and Macintosh may also be used. Computer users can view information available on servers or networks on the Web through the use of browsing software, such as Netscape Navigator, Microsoft Internet Explorer, Mosaic, or Lynx browsers. The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Other embodiments are within the scope of the following claims.

What is claimed is:

1. A method comprising:
locating a property for which a developer has received tax credits in exchange for constructing affordable housing units on the property;
by machine, storing information regarding the property into a database;
selling the tax credits held by the developer to an investor, the developer using equity received from the tax credits to finance, in part, construction of the affordable housing units;
transferring ownership of the housing units to qualified buyers; and
tracking ownership status of the affordable housing units.

2. The method of claim 1 wherein tracking includes
marking a deed to a housing unit with a restriction, the restriction indicating that at least one requirement must be met before the low-income household may sell the housing unit; and
by machine, storing information pertaining to the deed in a database.

3. The method of claim 1 further comprising verifying the eligibility of a family who applies for an affordable housing unit.

4. The method of claim 1 wherein the tax credits represent one-to-one tax compensation.

5. The method of claim 1 further comprising
generating a joint venture agreement between the investor and the developer, the joint venture agreement being a legally binding document; and
by machine, storing the joint venture agreement in electronic form in a database.

6. The method of claim 1 further comprising
pooling the tax-credited properties into funds;
selling the funds to the investors;
by machine, storing information pertaining to the funds in a database.

7. The method of claim 2 wherein tracking includes
determining if the low-income household wants to sell the housing unit; and
by machine, indicating in the information concerning the deed that the restriction on the deed was lifted.

8. The method of claim 1 further comprising generating reports displaying information that comprises:
the properties for which a developer has received tax credits;
the tax credits held by investors;
changes in ownership of the affordable housing units; and
profits generated by sales of the affordable housing units.

9. The method of claim 1 wherein the tax credits are used by the investor only after stages of the construction of affordable housing have been completed.

10. A system for providing affordable for-sale housing to low-income families using tax credits supplied from a government agency, the system comprising:
at least one client computer connected to a network, the client computer configured to receive information regarding a property for which tax credits have been allocated for affordable housing and a record of a sale of tax credits allocated to the property;
at least one database for storing information pertaining to the affordable housing units; and
a server connected to the network and to the database, the server configured to receive and transmit data between the client computer and the database; and to track the housing units.

11. The system of claim 10 wherein the database stores information regarding the tax credits.

12. The system of claim 10 wherein the database stores an electronic copy of a joint venture agreement between the investor and the developer.

13. The system of claim 10 further comprising a process to pool the tax credits into funds including other tax credits on other properties.

14. The system of claim 10 wherein information pertaining to the affordable housing units comprises completion progress, deed information, ownership information, and sales of the units.

15. The system of claim 10 wherein the client computer reports a portion of the information held in the database.

16. A computer readable medium having instructions stored thereon, that, when executed by a processor, causes the processor to:
store information regarding a property allocated for affordable housing into a database;
record an allocation of tax credits issued by a government agency to a developer of the property;
record a deed to an affordable housing unit on the property to a low-income family; and
track the affordable housing unit.

17. The computer readable medium of claim 16 further causing the processor to pool the tax credits into funds.

18. The computer readable medium of claim 16 further causing the processor to store a joint venture agreement between the developer and an investor.

19. The computer readable medium of claim 16 wherein the tracking comprises:
storing information pertaining the deed to the affordable housing unit, that the deed includes a restriction, the restriction indicating that at least one requirement must be met before the low-income household may sell the housing unit; and
storing information pertaining to the deed when the restriction is removed when the at least one requirement is met.

20. The computer readable medium of claim 16 wherein the tracking further comprises:
detecting if the low-income family is trying to sell the housing unit; and
detecting a foreclosure of the housing unit.

21. The computer readable medium of claim 16 further causing the processor to provide a report to a user containing information concerning the affordable housing unit.

22. The computer readable medium of claim 21 wherein the information concerning the affordable housing unit comprises: completion progress, deed information, ownership history, and financial information.

23. A method comprising:
locating a property for which a developer has received tax credits in exchange for constructing affordable housing units on the property;
selling the tax credits held by the developer to an investor,
using by the developer equity received from the sale of the tax credits to finance, in part, construction of the affordable housing units; and
transfer the affordable housing units to qualified purchasers.
